(19) United States
(12) Patent Application Publication
(10) Pub. No.: US 2011/0029853 A1
(43) Pub. Date: Feb. 3, 2011

(54) ADVANCED VISUALIZATIONS IN ANALYTICS REPORTING

(75) Inventors: Justin Garrity, Hillsboro, OR (US); Ryan Parr, Hillsboro, OR (US); David Stewart, Portland, OR (US); Nicholas Fedoroff, Portland, OR (US); Adam Keene, Portland, OR (US)

Correspondence Address: MARGER JOHNSON & MCCOLLOM, P.C., 210 SW MORRISON STREET, SUITE 400, PORTLAND, OR, 97204, US

(73) Assignee: WEBTRENDS, INC., Portland, OR (US)

(21) Appl. No.: 12/849,749

(22) Filed: Aug. 3, 2010

Related U.S. Application Data
(60) Provisional application No. 61/230,982, filed on Aug. 3, 2009.
(60) Provisional application No. 61/230,984, filed on Aug. 3, 2009.
(60) Provisional application No. 61/230,987, filed on Aug. 3, 2009.

(51) Int. Cl. G06F 3/048; G06F 15/16

(52) U.S. Cl. 715/215; 709/217

(57) ABSTRACT

A method and apparatus is disclosed for enabling advanced visualization techniques for conveying analytics information to a user. For the presentation of analytics data within a natural language statement or series of statements, a template is stored in a template database and includes natural language statements with data fields embedded within the statements. The data fields are populated with the appropriate analytics data such that the resulting reporting statement reads like a conversational statement of data and trends. Other advanced data visualizations of analytics helps one to quickly understand changes in key metrics for an entire account, compare the performance of reports across profiles, plot RSS feed events against metrics, and easily share data with others in ones organization.

### CROSS-REFERENCES TO RELATED APPLICATIONS

This application claims the benefit from U.S. Provisional Patent Application Nos. 61/230,982, 61/230,984, and 61/230,987 all filed Aug. 3, 2009 whose contents are incorporated herein for all purposes.

### BACKGROUND OF THE INVENTION

1. Field of the Invention.

The present application relates to data visualization, and more particularly methods and systems for more effectively presenting analytics information to a user of such information.

2. Description of the Prior Art.

Programs for analyzing traffic on a network server, such as a worldwide web server, are known in the art. One such prior art program is described in U.S. Pat. No. 6,925,442, titled a Method and Apparatus for Evaluating Visitors to a Web Server, which is incorporated herein by reference for all purposes. Another such prior art system is described in U.S. Pat. No. 6,112,238, titled System and Method for Analyzing Remote Traffic Data in a Distributed Computer Environment, which is also incorporated herein by reference for all purposes. Webtrends Corporation owns this application and also owns the present provisional application. In these prior art systems, the program typically runs on the web server that is being monitored. Data is compiled, and reports are generated on demand are delivered from time to time via email—to display information about web server activity, such as the most popular page by number of visits, peak hours of website activity, most popular entry page, etc.

Analyzing activity on a worldwide web server from a different location on a global computer network (“Internet”) is also known in the art. To do so, a provider of remote web-site activity analysis (“service provide”) generates JavaScript code that is distributed to each subscriber to the service. The subscriber copies the code into each web-site page that is to be monitored. When a visitor to the subscriber's web site loads one of the web-site pages into his or her computer, the JavaScript code collects information, including time of day, visitor domain, page visited, etc. The code then calls a server operated by the service provider—also located on the Internet—and transmits the collected information thereto as a URL parameter value. Information is also transmitted in a known manner via a cookie. Each subscriber has a password to access a page on the service provider's server. This page includes a set of tables that summarize, in real time, activity on the customer's web site.

The above-described arrangement for monitoring web server activity by a service provider over the Internet is generally known in the art. Information analyzed in prior art systems consists of what might be thought of as technical data, such as most popular pages, referring URLs, total number of visitors, returning visitors, etc., as well as commercial activity, e.g. products purchased, time of purchase, total amounts, etc.

The amount of information that must be digested by a user of the traffic analytics tool is immense. Typically, such information is presented in graphical form (e.g. FIGS. 2-5) or as naked numbers. While experienced technologists might be comfortable with such graphs and numbers, managers might not digest this information as easily. Furthermore, the trending of this information over time, particularly when such data quickly peaks or craters, is not always best understood without context.

Accordingly, the need remains for visualization techniques that present data in ways that may be more useful to a wider array of people, and that incorporate contextual information within graphical or charted trend data so that the meaning of the trends, in connection with time-sensitive events, may be better understood.

### SUMMARY OF THE INVENTION

In one aspect of the invention for advanced visualization techniques for conveying analytics data, a method and apparatus is disclosed for embedding the presentation of analytics data within a natural language statement or series of statements. A template, stored in a template database, includes natural language statements with data fields embedded within the statements. The data fields are populated with the appropriate analytics data such that the resulting reporting statement reads like a conversational statement of data and trends.

The invention, also called “story view” is a unique new way to view key metrics data. Instead of visualizing it with a graph or chart, story view embeds the data into a narrative paragraph providing written context for what the data is indicating.

In another advanced visualization technique, an RSS feed is associated with three types of information: article title, the article itself, and the date/time of publication. The time from the RSS feed article is read by a data incorporator and overlay directly on top of the trended key metric at the appropriate timeline location. Key metrics data include such items as page views or time-on-site. Feeds are correlated with the web page or site and simultaneously posted articles are superimposed using a heatmapping (e.g. progressively darker shading) to indicate a density of events.

Other advanced visualization features described in the invention include: (a) comparing profiles and spaces, (b) intelligent type-ahead for meta-data, (c) multi-level pivot navigation, (d) weekend overlay in trend view, and (e) quick stats for individual days.

Comparison of profiles can be done side-by-side on a display, where the current performance is measured against the past and displayed in the same report in different profiles.

The intelligent type-ahead filters allow reports to be filtered by meta-data type occurring within the reports. Typing several letters within a search field begins the process of presenting several possible filters that may be selected. Upon selection, the reports displayed are narrowed so that only those satisfying the particular filter are included.

Pivot navigation allows one to compare other profiles across various levels of a navigation bar. The same report, but different profile, may thus be selected from the menus.

Weekend overlay provides visual indicia in combination with the graph of analytics data so that the data points occurring over weekends may be easily seen and weekends correlated. In a preferred embodiment, the weekends are shown by vertical bars on the chart. Data reporting periods can be artificially limited to 1 week, 4 week, and 13 week periods so that two charts may be overlaid with properly overlapping weekend.

Quick stats associate days of the reporting period with certain pre-defined analytics events—typically data extremes. The occurrence of multiple such events on a single day can thus give indication that such was triggered by a particular event (such as a press release) thus prompting further investigation.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a schematic view of a portion of the Internet on which the invention is operated.

FIG. 2 is an illustration of a conventional web page order form including embedded programmatic code operable to gather commercial activity according to the invention.

FIG. 3 is an example of a report showing revenue trends over time throughout a business day as tracked and reported by the present invention.

FIG. 4 is an example of a report showing revenue by product over a month's period as tracked and reported by the present invention.

FIG. 5 is an example of a report showing revenue trends at a particular web site over the course of an entire year for five different products as tracked and reported by the present invention.

FIG. 6 is a workflow diagram illustrating an operation of the invention to present a story view of analytics data using a natural language template populated with such data.

FIG. 7 is a schematic diagram illustrating operation of data flow the invention of FIG. 6.

FIG. 8 is a screen shot of a story view output constructed according to a preferred implementation of the invention.

FIG. 9 is a screen shot of a story view output in combination with a highlights field according to a preferred implementation of the invention.

FIG. 10 is a screen shot of a meta-data search field within a reports page according to a preferred implementation of the invention.

FIGS. 11A-11D are charts that include weekend overlay indicia according to a preferred implementation of the invention.

FIG. 12 is a chart showing weekend overlay indicia and preset time period selectors according to a preferred implementation of the invention.

FIG. 13 is a workflow diagram illustrating an operation of the invention to present an overlay of events from an RSS feed on top of time-plotted analytics data according to teachings of the invention.

FIG. 14 is a screen shot showing an analytics graph of page views without an RSS feed (event) overlay.

FIG. 15 is a screen shot showing an analytics graph of page views with an RSS feed (event) overlay according to teachings of the invention.

FIG. 16 is a screen shot showing display of analytics tracking system in compare mode where the trend of multiple profiles are displayed over a selected time period according to methods of the invention.

FIG. 17 is a screen shot showing display of a pivot function of the analytics visualization system of the invention.

APPENDIX I and APPENDIX II illustrate script that may be incorporated into a web page to gather analytics data from the browser requesting the web page.

### DETAILED DESCRIPTION

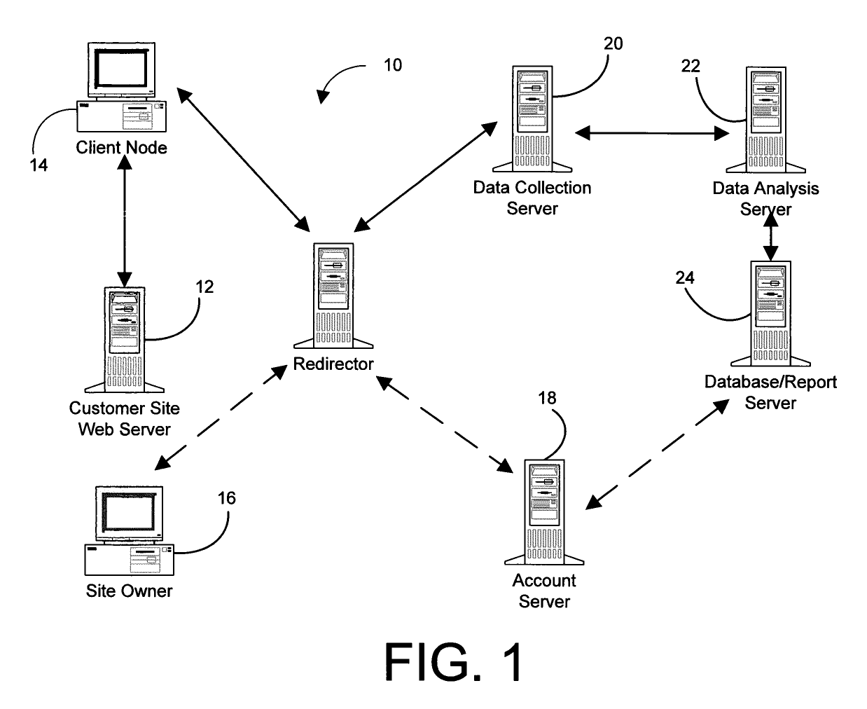

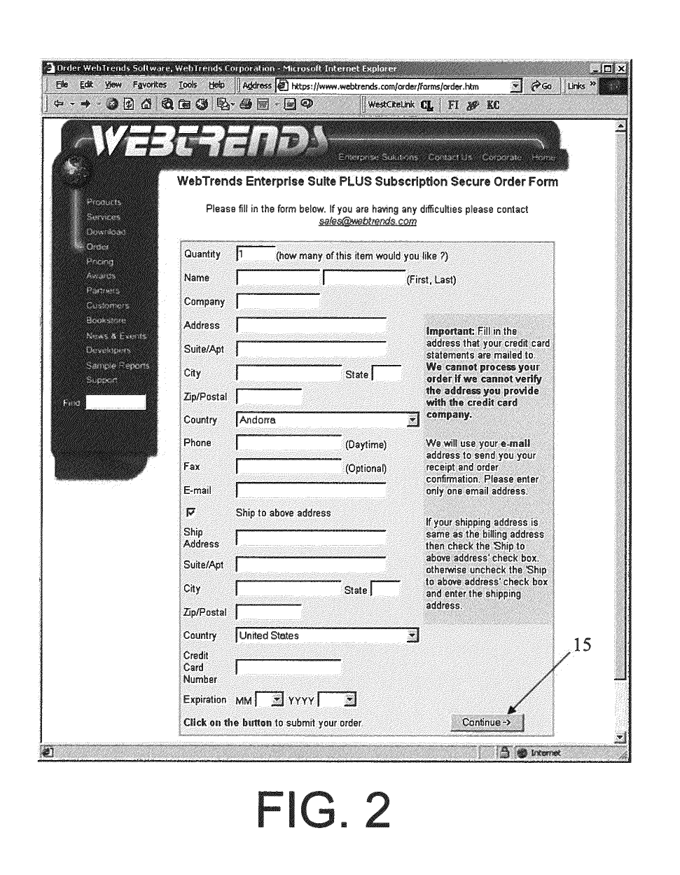

Turning now to FIG. 1, indicated generally at 10 is a highly schematic view of a portion of the Internet. FIG. 1 depicts a system implementing the present invention. Included thereon is a worldwide web server 12. Server 12, in the present example, is operated by a business that sells products via server 12, although the same implementation can be made for sales of services via the server. The server includes a plurality of pages that describe the business and the products that are offered for sale. It also includes an order page, like the one shown in FIG. 2, that a site visitor can download to his or her computer, like computer 14, using a conventional browser program running on the computer. The order form typically contains—for products—the national currency that the seller accepts, an identification of the product, the number of products sold, and the unit price for each product. After a site visitor at computer 14 fills in the information in FIG. 2, the visitor actuates a screen-image button 15 that places the order by transmitting the information from computer 14 to server 12 over the network. Upon receipt of this information, server 12 typically confirms the order via email to computer 14. The seller then collects payment, using a credit-card number provided in the FIG. 2 form, and ships the product.

As mentioned above, it would be advantageous to the seller to have an understanding about how customers and potential customers use server 12. As also mentioned above, it is known to obtain this understanding by analyzing web-server log files at the server that supports the selling web site. It is also known in the art to collect data over the Internet and generate activity reports at a remote server.

When the owner of server 12 first decides to utilize a remote service provider to generate such reports, he or she uses a computer 16, which is equipped with a web browser, to visit a web server 18 operated by the service provider. On server 18, the subscriber opens an account and creates a format for real-time reporting of activity on server 12.

To generate such reporting, server 18 provides computer 16 with a small piece of code, typically JavaScript code (data mining code). The subscriber simply copies and pastes this code onto each web page maintained on server 12 for which monitoring is desired. When a visitor from computer 14 (client node) loads one of the web pages having the embedded code therein, the code passes predetermined information from computer 14 to a server 20—also operated by the service provider—via the Internet. This information includes, e.g., the page viewed, the time of the view, the length of stay on the page, the visitor's identification, etc. Server 20 in turn transmits this information to an analysis server 22, which is also maintained by the service provider. This server analyzes the raw data collected on server 20 and passes it to a database server 24 that the service provider also operates.

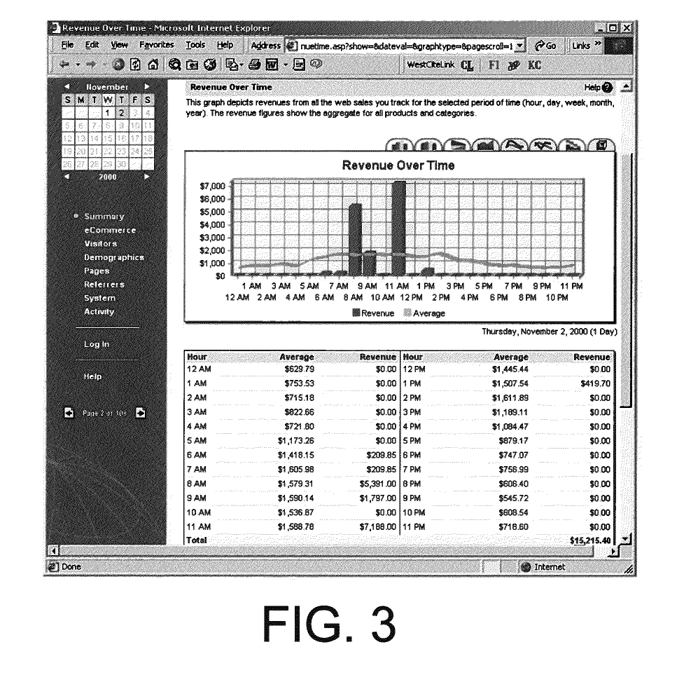

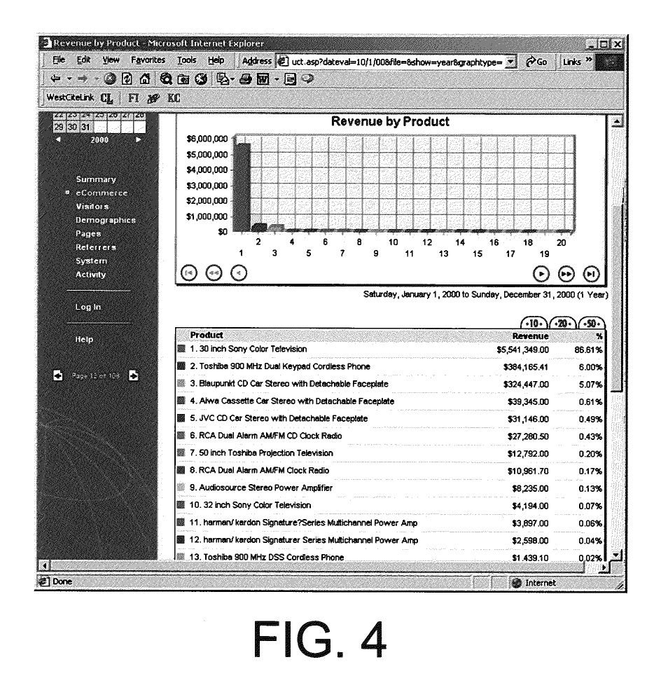

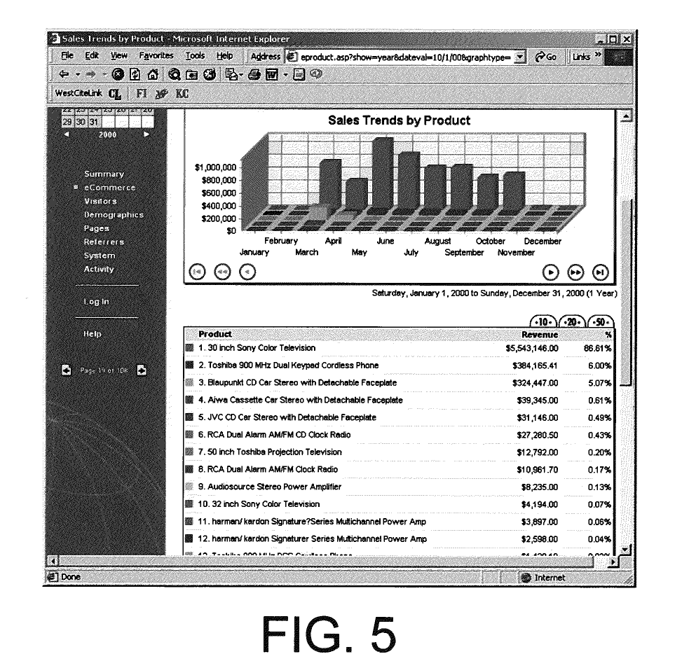

When the subscriber would like to see and print real-time statistics, the subscriber uses computer 16 to access server 18, which in turn is connected to database server 24 at the service provider's location. The owner can then see and print reports, like those available through the webtrendslive.com reporting service operated by the assignee of this application (examples of which are shown in FIGS. 3-5), that provide real-time information about the activity at server 12.

The data mining code embedded within the web page script operates to gather data about the visitor's computer. Also included within the web page script is a request for a 1×1 pixel image whose source is server 20. The 1×1 pixel image is too small to be viewed on the visitor's computer screen and is simply a method for sending information to server 20, which logs for processing by server 22, all web traffic information.

The data mined from the visitor computer by the data mining code is attached as a code string to the end of the image request sent to the server 20. By setting the source of the image to a variable built by the script (e.g. www.webtrendslive.com/button3.asp? id39786c45629t120145), all the gathered information can be passed to the web server doing the logging. In this case, for instance, the variable script “id39786c45629t120145” is sent to the webtrendslive.com web site and is interpreted by a decoder program built into the data analysis server to mean that a user with ID#39786, loaded client web site #45629 in 4.5 seconds and spent 1:20 minutes there before moving to another web site.

As will now be explained, applicant has developed the ability to analyze commercial data as well, e.g., number of orders, total revenues, etc., generated by server 18, and attach that information to the variable script image request so that commercial activity for a particular site can be tracked.

To this end, applicant has developed a method in which data relating to revenues, products sold, categories of products, etc., is collected, analyzed and displayed in various report formats. An example of code that can be used to implement this method is shown in Appendices I and II. When the subscriber opens an account with the service provider by connecting computer 16 to server 18, as described above, the code in Appendices I and II is transferred from service 18 to computer 16 in a known manner. The subscriber then determines which pages on the server 12 web site he or she would like to track. The subscriber then opens a text editor for each page to be tracked, and the code from Appendix I is pasted into the bottom of the page. Although the code in Appendix I does not provide an image on the page, it should be appreciated that code that includes an image such as a logo or the like, could be included in the Appendix I code. This would consequently both track the page and display an image thereon.

After the Appendix I code is pasted onto each page to be tracked, including an order confirmation page, the code in Appendix II, which defines a variable called ORDER, is also pasted onto the order confirmation page. This variable appears on line 7 of the Appendix I code.

The variable ORDER, among other things, defines the currency that is used to purchase the product. The currency need only be entered once, and in the example is USD for U.S. dollars. There are four other items that are included in the variable for each product ordered. In the order appearing in the variable they are first, the product name; second, the category that the product is in; third, the number of products purchased; and fourth, the unit price for the product. As can be seen in the Appendix II code, each item of information in the ORDER variable is included for each product purchased.

In operation, a site visitor using computer 14 first fills in all the information in the FIG. 2 form. The visitor then clicks button 15 in FIG. 2, and an order confirmation page (not shown) appears that includes the product, category, number, and unit price information, for each product ordered. The code in Appendices I and II collect this information, along with the usual data relating to traffic, visitors, visitors' systems, etc., and transmits it to service 20. This data is analyzed on server 22 as described above and stored on database 24.

An example of this process is described as follows. The variable image source constructed by the inserted commercial activity tracking script can be shown as, for instance, www.webtrendslive.com/button3.asp?usd-lawn_chair#1-1445-002-2499, corresponding to price in U.S. dollars, product name: “lawn chair #1”, product category #1445, 2 units sold at a per unit price of $24.99. Decoder software operable within server 22 reverse engineers the order to extract commercial activity data based on the source of the image requests.

When the business owner operating the website on server 12 wants to determine activity on that site, he or she logs onto his or her account on web server 18 via computer 16. After entering the appropriate user name and password, reports that are maintained in real time, as described above, are accessed, viewed, and—if desired—printed by the subscriber. Examples of various reports are shown in FIGS. 3-5 and are available through the webtrendslive.com reporting service, operated by the assignee of this application.

In addition to viewing the reports that are maintained in real time, the account owner can define time periods during which the information can be displayed in the format shown in the enclosed reports. There is also a feature that the account owner can select to cause reports to be periodically mailed to computer 16.

### Natural Language Presentation of Web Analytics

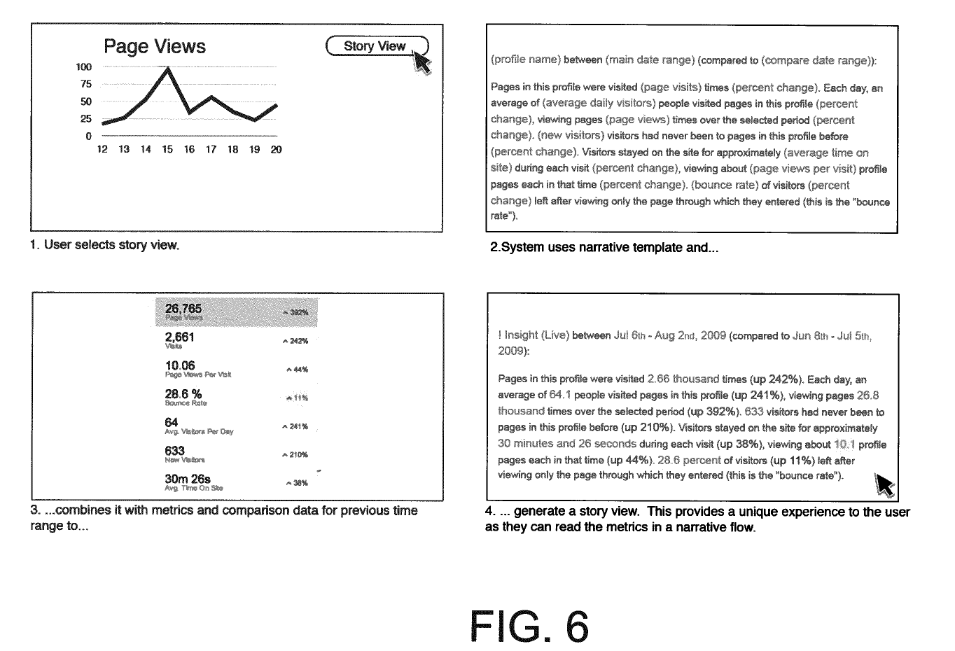

FIGS. 6-8 illustrate one aspect of invention where the advanced visualization of web analytics is realized by presenting web traffic statistics and the like in a natural language narrative that can then be copied and pasted into presentations such as PowerPoint.

FIG. 6 illustrates a workflow diagram with block (1) illustrating a graph of page views resulting over a designated period of time. The information is presented graphically such that the number of page views per hour, and the page view trend over time, may be observed. Operation of the invention allows a user to select a story view button. Selecting the button causes the system to operate in story view mode.

In story view mode, a natural language template [block (2)] is selected from a template database. The template includes fixed natural language statements interspersed with data fields. In the template illustrated in FIG. 6, for instance, the fixed portion in the first line includes“*profile name field* between *main date range* (compared to *compare date range*):” with the portion italicized and underlined being the data fields whose values are drawn from an analytics database. The appropriate metrics from the analytics database(s) are called as in block (3) and inserted within the appropriate locations within the template. The resulting first part of the report would read as follows: “Inside (Live) between Jul 6^{th}-Aug. 2^{nd} (compared to Jun 8^{th}-Jul 5^{th}, 2009):”. The natural language template, with metrics or data fields inserted, costs of a narrative of multiple statements that together present a syntactical flow of information in paragraph form as would normal speech rather than bullet points of unrelated statements. In this way, communication is presented to a user much in the way as human speech.

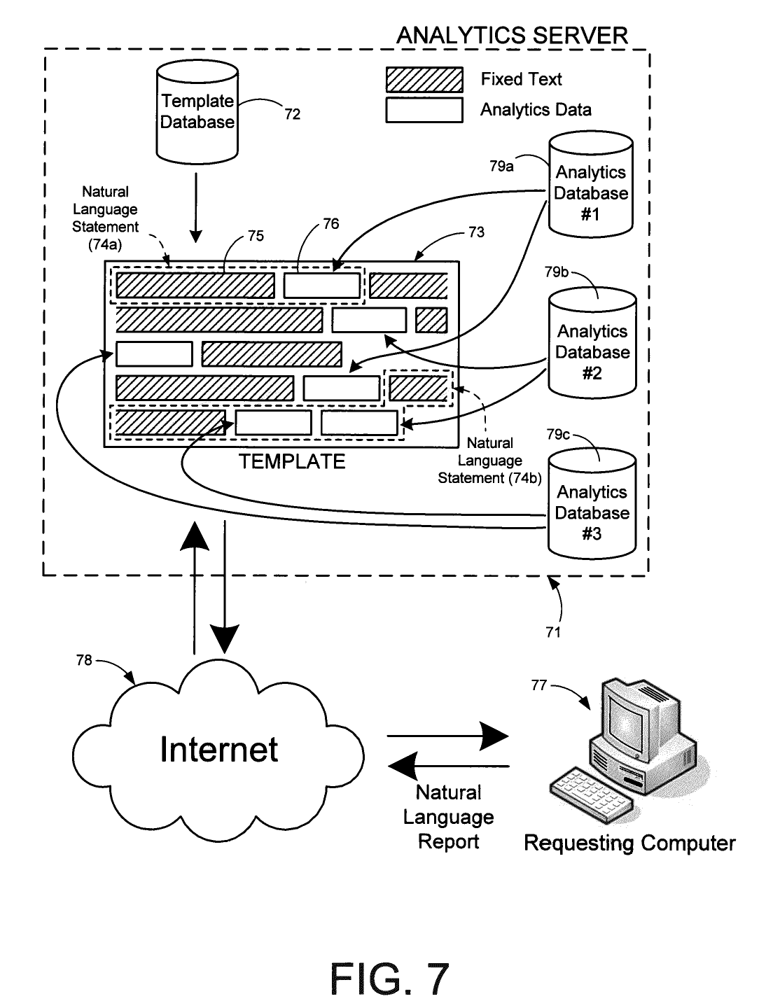

FIG. 7 illustrates a more schematic view of the hardware elements and data flow of the present invention. Operating within an analytics server 71, the template database 72 provides a template 73 of fixed information and fields where data may be incorporated. Template 73 preferably includes a plurality of natural language statements—such as statements 74a and 74b—with such statements including at least a fixed text field 75 and an analytics data field 76. Upon request of the client computer 77 through a wide area network such as the Internet 78, the analytics server constructs a report from the template 73 by populating the appropriate data into the template from one or more analytics databases 79a, 79b, 79c and serving the now-completed template report back to the requesting client computer 77.

Preferably, each of the plurality of natural language statements—such as statements 74a and 74b—include at least one data field 76. When the data for the data field is not available, the resulting statement is an incomplete statement. The system is configured to remove an incomplete natural language statement from the template if a data field associated with the incomplete natural language statement is missing so that the missing information does not take away from the narrative.

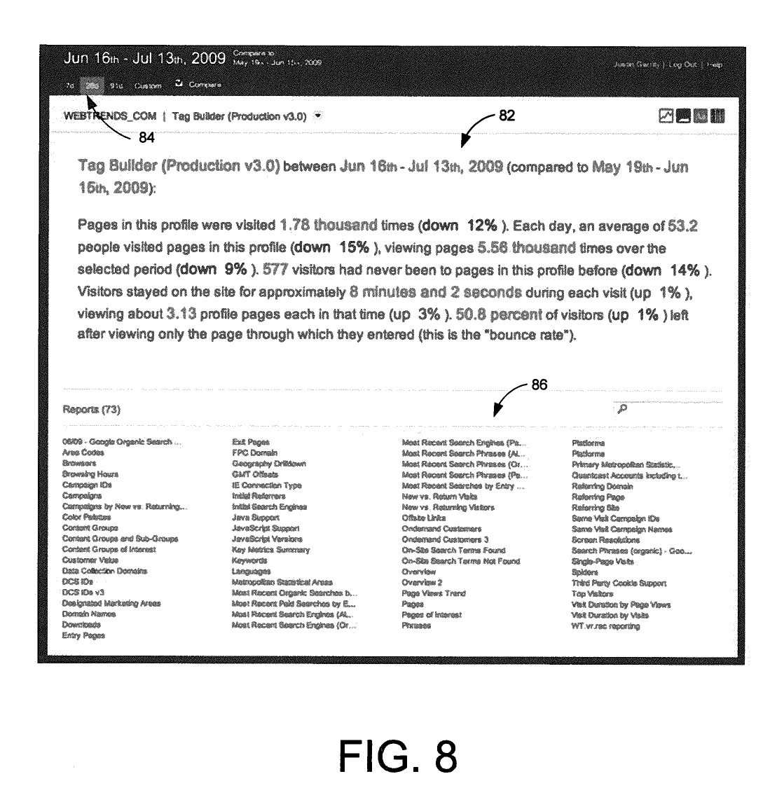

FIG. 8 illustrates a completed natural language paragraph 82 that is served to a user of the system. The time period selection field 84 (e.g. 28 days) over which the trends are presented, and the types of reports available in report selector field 86, are also included within the page shown.

### Highlights of Statistically Significant Periods in Analytics Reporting

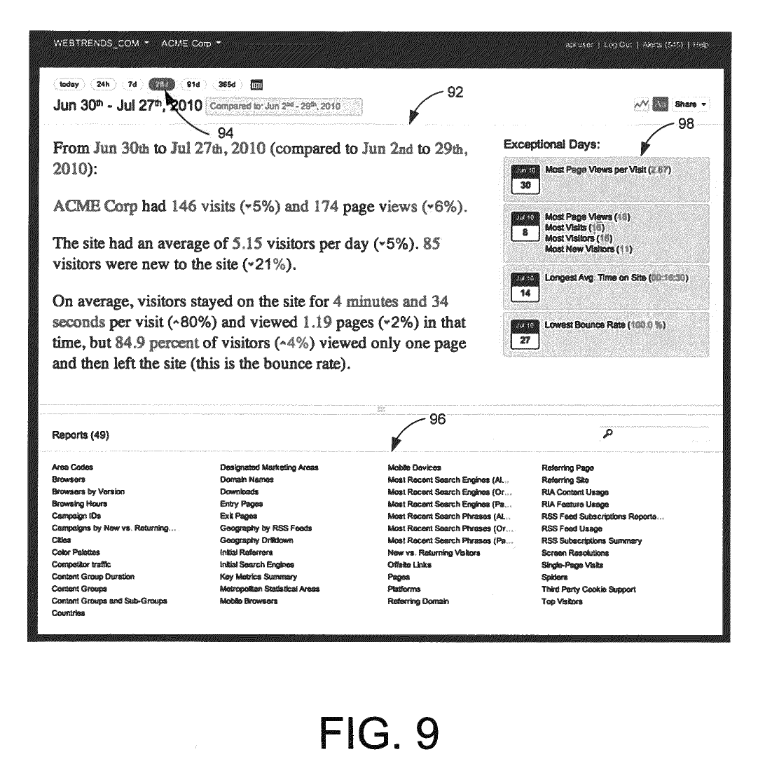

FIG. 9 illustrates a modification to the graphic user display of FIG. 8—including natural language paragraph presentation block 92, time period selection field 94, and report selector field 96—to which is added a highlight feature of exceptional days. Highlights field 98 is located adjacent the natural language paragraph presentation block 92 and lists the extreme points of seven different metrics and their association/groupings with particular dates within the time period selected. Accordingly to a preferred embodiment of the invention, the metrics listed in the highlights field 98 include the following:
Longest Average Time on Site
Lowest Bounce Rate
Most New visitors
Most Page Views
Most Page Views Per Visit
Most Visits
Most Visitors

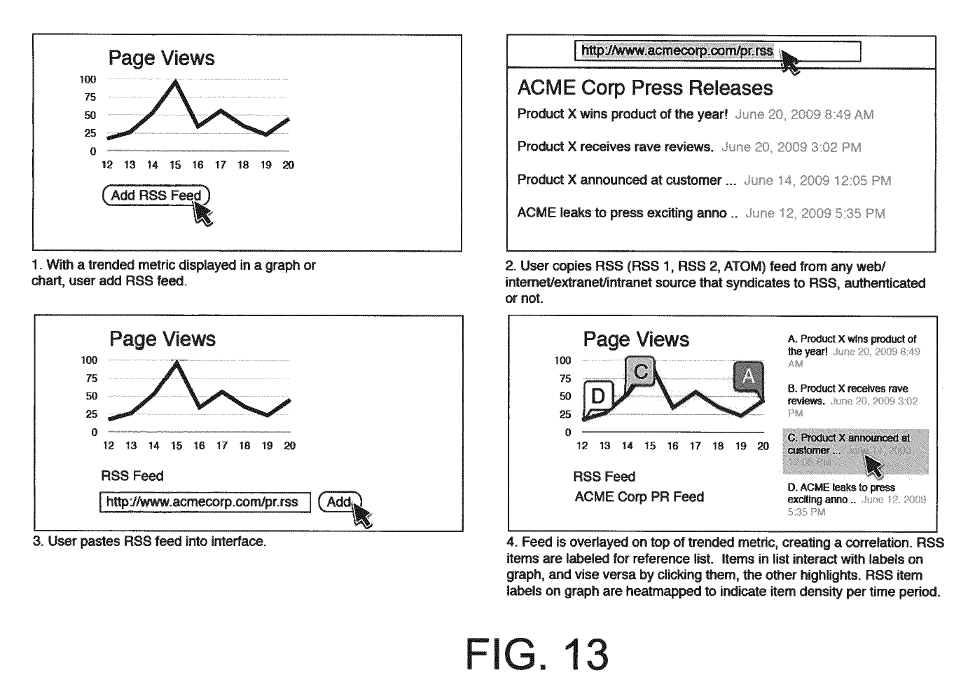

The highlights field 98 is divided into sections illustrating the different days on which the extreme points of the measured metrics occurred. Trends can then be determined as by: number of extremes within a certain date, and number of extremes in close date proximities. From the highlights field 98 of FIG. 9, it can be easily seen that Jul. 8, 2010 was an exceptional date for the ACME Corp website as resulting in four of the seven measured metric extreme points, including most page views, most visits, most visitors, and most new visitors. From this, further investigation can take place to determine why such extremes took place on that day, as by using other aspects of the invention such as the RSS mapping function of FIG. 13.

### Intelligent Type-Ahead for Meta-Data

Reports generated using aspects of the invention present meta-data or metrics into a visual form and arrangement that enhances comprehension of complex concepts. Several examples discussed above include the natural language presentation of data using a syntactic narrative or conversational language as shown in FIGS. 6-8; while FIG. 9 illustrates use of a highlights field to display an exceptional days within the time period selected. FIG. 9 further illustrates the vast number of possible reports or profiles available to a user as displayed within report selector field 96.

Each report is associated with one or more meta-data or metrics. In the example shown in FIG. 9 for ACME Corp., the natural language narrative includes metrics for data ranges, visits, page views, average visitors per day, new visitors, visitor stay, pages viewed, and single-page visits. A method for finding appropriate reports is desired.

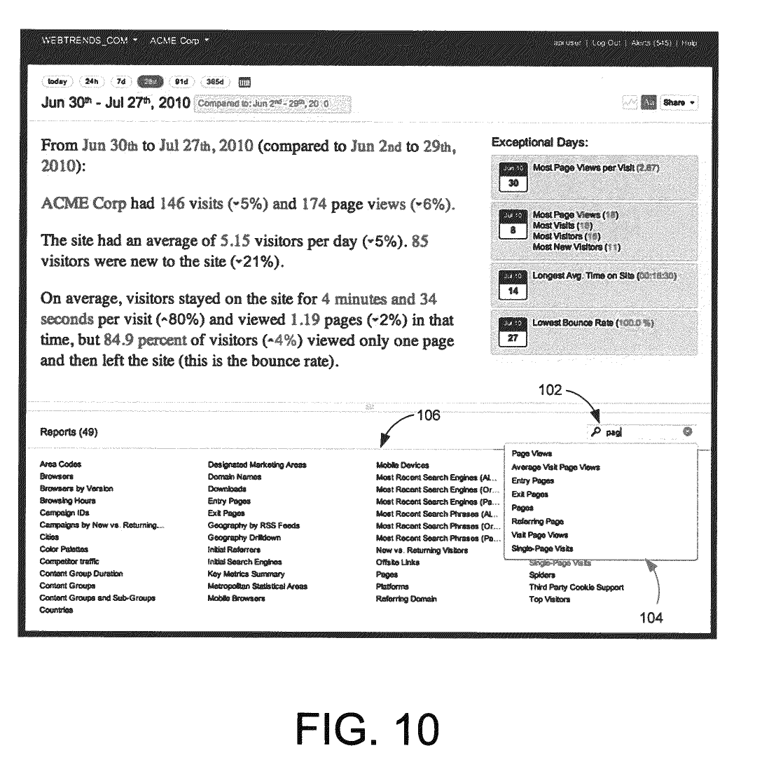

FIG. 10 illustrates an aspect of the invention using type-ahead intelligence. Entry field 102 adjacent report selector field 106 allows a user to enter meta-data search terms. In a preferred embodiment, data look-up occurs once a user has typed in three letters—as shown where the letters “pag” have been typed in. The letters typed are cross-referenced in a look-up table with the list of possible meta-data terms so that a user can select from the narrowing list rather than be required to know the exact name of the meta-data used within any of the reports. The three letters “pag” result in eight different meta-data functions displayed within a drop-down list 104 underneath entry field 102; any one of which can then be selected by highlighting and then selecting. Upon entry, the number of reports shown is narrowed to reflect only those that report on the meta-data term selected.

### Weekend Overlay

Web analytics reflect behavior patterns of visitors. The number of web page visits on weekends may be very different than how many visits to the web page occur during regular weekdays. For instance, a website that displays and comments on the current price of certain stocks would be expected to have fewer visitors on the weekends when the markets are closed. Other commercial websites may exhibit similar analytics patterns, having more visits during the week during normal operating hours. Conversely, some other websites such as leisure sites (e.g. Fandango or other movie sites) might have more business during the weekend than the weekday. The end result is that the peaks and valleys that show up on analytics graphs occur with periodic and oftentimes, predictable, frequency. And while such variations may make it obvious when weekends occur, it would be helpful to have an additional visual indicator or weekend overlay on the displayed chart or graph.

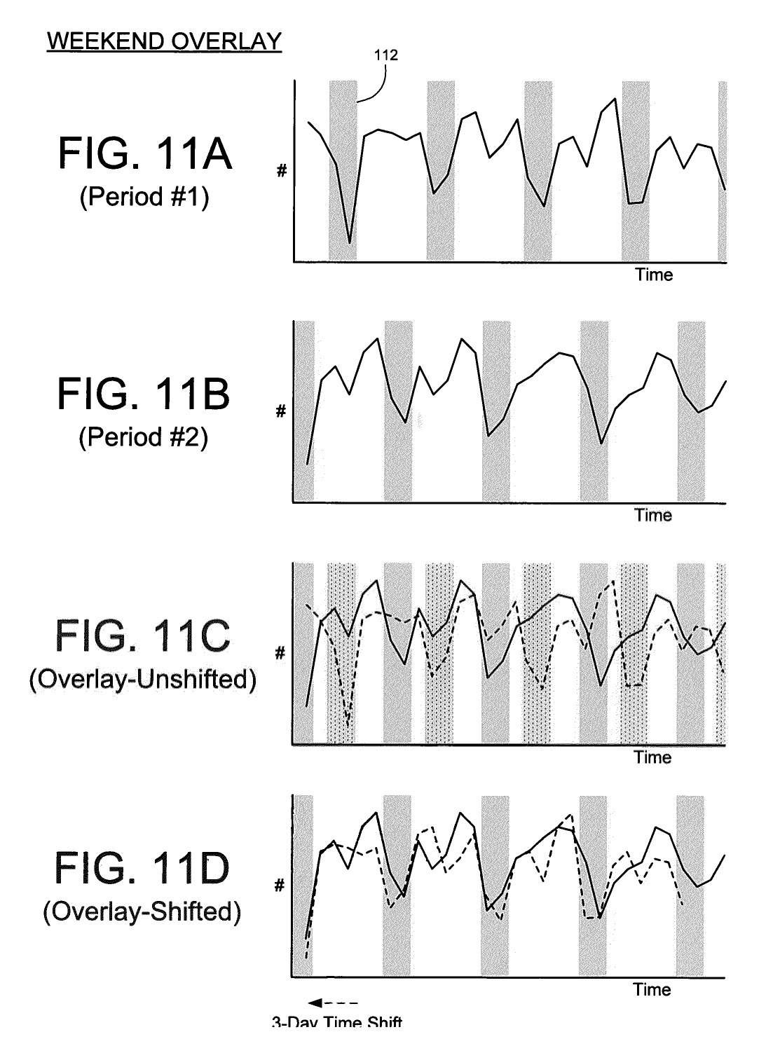

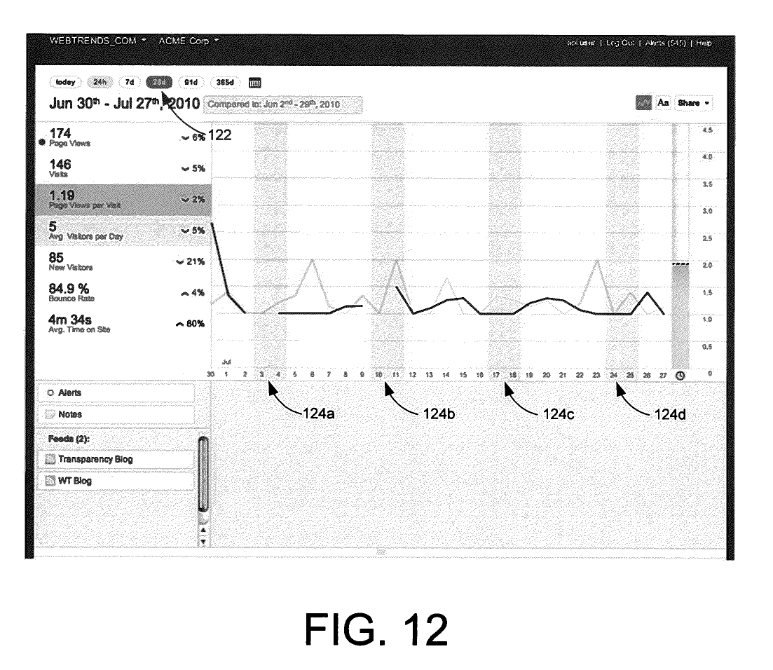

FIGS. 11 and 12 illustrate graphical weekend indicators. When viewing graphs and charts where time is a dimension, weekend indicators display a unique marking (a light gray overlay in the current implementation) to let the user know when the weekends are compared to the rest of the week. In compare mode, the time range selectors for month and quarter are 28 day and 91 day. These numbers, each divisible by seven, allow the user to retain weekend overlays when comparing time over time.

FIGS. 11A-11D illustrate a weekend overlay on an analytics graph charted over the period of a month. The timeline is shown along the x-axis while the analytics number tracked is along the y-axis. FIGS. 11A and 11B illustrate analytics tracked over the course of two different months each having 31 days. Traditionally, the line graph is projected against a solid white background with no immediate indication of the type of day (e.g. weekend versus weekend) the data point occurs. FIGS. 11A and 11B, however, include visual indicia—in the form of vertical columns 112 of a different color or grayscale—indicating weekends. One notes that the tracked analytics exhibit a dip during the weekend over both tracked months.

FIG. 11C illustrates a direct overlay the two graphs of FIG. 11A and 11B. Because the weekends show up in different parts of each of the graphs, the periodic dip that was so obvious in each graph individually is lost so that trends by day of the week are not easily determined.

FIG. 11D illustrates the graph of FIG. 11C that has been time-shifted so that weekends are aligned in both graphs. In this example, one of the periods is time-shifted by three days. The weekend indicators then align along the time-axis of the graph and the dips and peaks are more easily superimposed to show patterns of behavior.

Another aspect of the invention is shown in FIG. 12 where the time period selection field 122 includes periods divisible by 7 day increments (e.g. 7 days, 28 days, and 91 days) so that the charts need not be time shifted in overlay mode. Because the time periods are divisible by 7, the beginning and ending days of the week for the current and the immediately preceding time periods compared properly align. In the example shown in FIG. 12, tracking for the current and immediately preceding time period start on a Wednesday and end on a Tuesday. Each of the weekend indicators 124a, 124b, 124c, and 124d therefore line up.

### RSS Overlay for Charts

FIG. 13 illustrates a workflow diagram with block (1) illustrating a graph of page views resulting over a designated period of time. The information is presented graphically such the number of page views per day, and the page view trend over time, may be observed. Operation of the invention allows a user to select an “add RSS feed” button to associate with the graph or chart of analytics trend data.

Selecting the button causes the system to transition to an RSS feed entry mode wherein the feed URL (e.g. http://www.acmecorp.com/pr.ss) is entered by a user of the system as in block (2). The RSS feed is standardized to have an article title field, the article itself, and a date posted field. The data posted for each event in the RSS feed is mapped to the graph in block (3).

Block (4) illustrates a user view of the RSS data superimposed on the graphical trend data. It is observed, for instance, that the last date shown (June 20) includes two RSS fee article publications. Both are posted with a label ‘A’ and ‘B’, respectively, on the ‘20’ portion of the graph. The ‘B’ article is obscured on the graph because it occurs later in time than article ‘A’. Because multiple articles occur on that day, and to distinguish it against times where only a single RSS feed occurs (e.g. flags ‘D’ and ‘C’), the ‘A’ flag is darkened compared to the others to indicate a density of events on that day. The articles, or just titles of summaries of the RSS feeds, are displayed in conjunction with the graph.

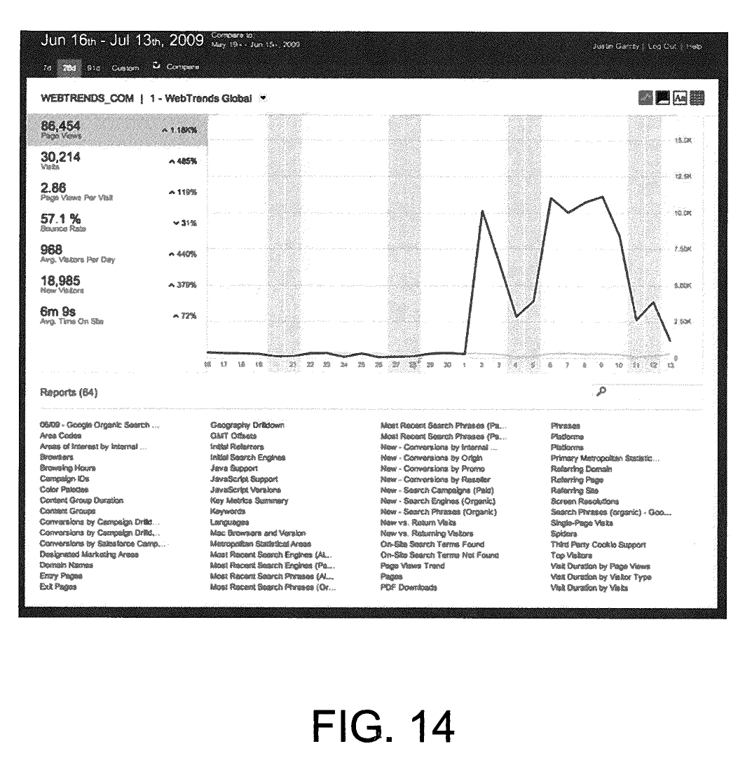

FIG. 14 illustrates a page view graph of a web site over a 28 day period. The RSS feed data is not displayed concurrently with the graph data. Accordingly, a user would be unaware of the events that correlate with the strong peaking of page view data that occurs on July 1.

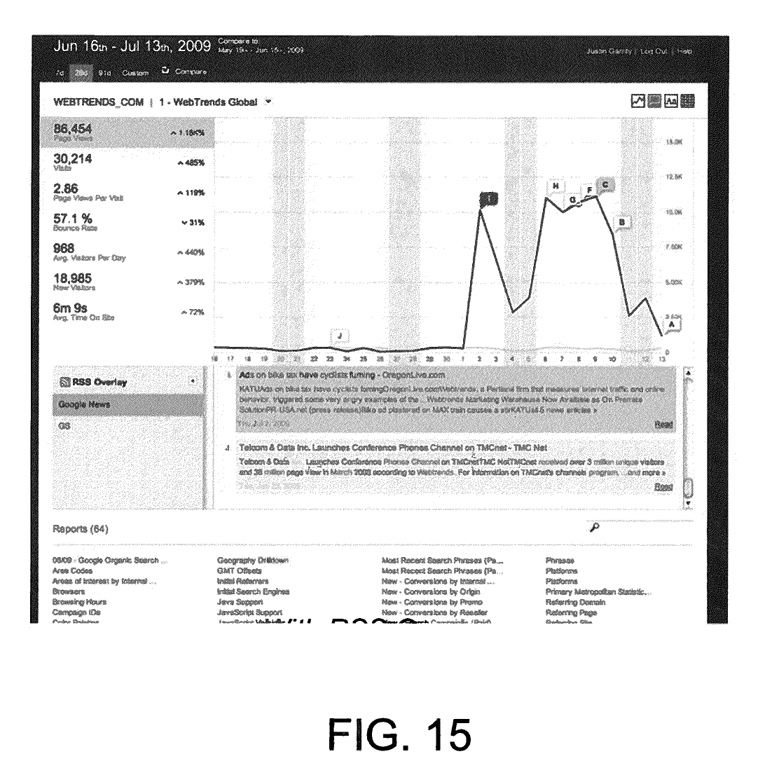

FIG. 15 illustrates a page view graph of a web site over a 28 day period but, unlike FIG. 14, includes mapped RSS feed data. One notes, for instance, that item ‘I’ shows that a particular published article of some controversy may have been published at the time of the upward page view trend, thereby indicating that the article probably contributed to the atypical trend data. Users may then use this information for future publications planning to maximize the popularity (e.g. page views) on the web site.

The invention can be generalized to any time of data feed, of which an RSS feed is but an example, and is not intended to be limited solely to the examples given.

### Compare Profiles and Spaces

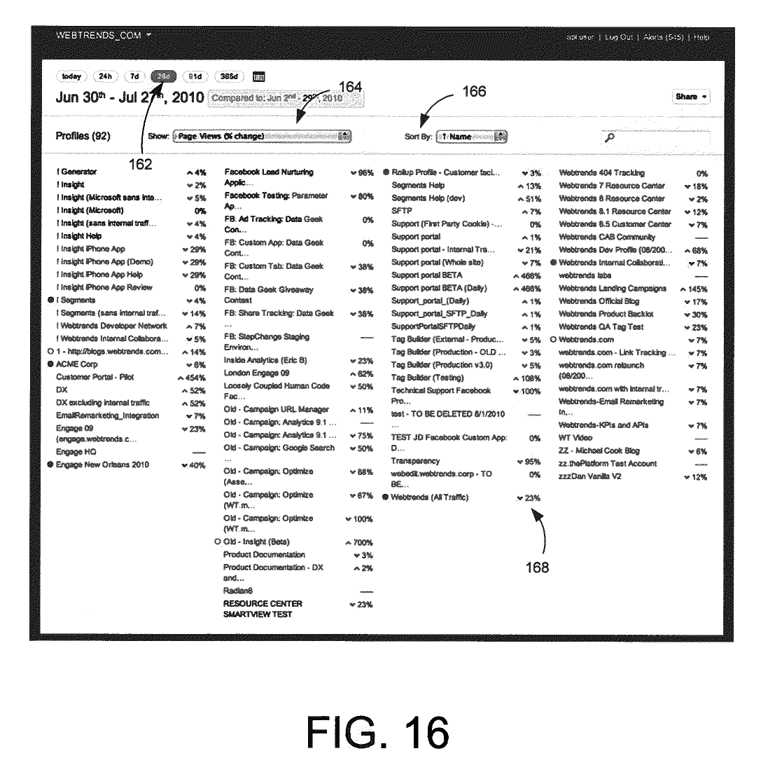

FIG. 16 illustrates a graphic user interface view screen shot of the invention placed in compare profiles view. Options selectable include a date range 162—as compared to the previous period of the same date range-as well as the data compared 164—here the percentage change of page views between the earlier and later date ranges—and a sorting criteria 166—here alphabetically by name. The profiles are listed in alphabetical order with a trend number displayed—e.g. that the number of page views in the current time period has gone down by 23% from the previous time period.

Other types of data that can be compared within data compared field 164 include: Visits, Visits % Change, Page View per Visit, Page Views per Visit % change, Bounce Rate, Bounce Rate % change, Avg. Time On Site, and Avg. Time On Site % change. Other sorting means selectable within the sort field 166 include: Name ↑, Name ↓, Measure ↑, Measure ↓ (where ↓ means “descending” and ↑ means “ascending”).

### Multi-Level Pivot Navigation

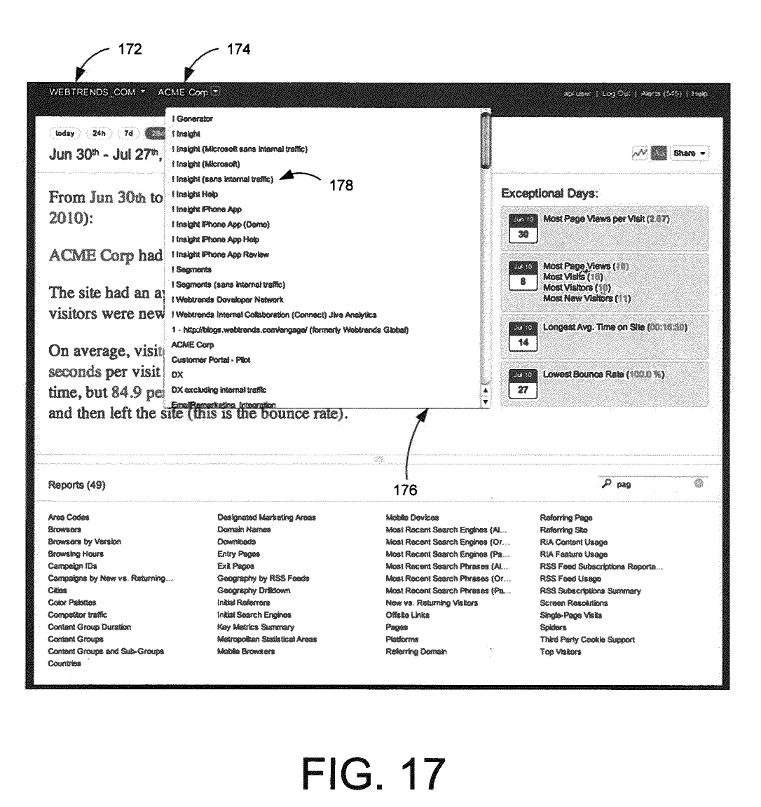

FIG. 17 illustrates a graphic user interface view screen shot of the invention showing pivot navigation around a single data axis, profile. A first level structure, item 172, illustrates a grouping of data items with a second level structure, item 174, being a profile maintained in a subfolder within item 172. Further subfolders of item 174 are possible with each having menu-selected subitems.

FIG. 17 shows the narrative screen for the ACME Corp profile. The date range is already selected. Other narrative screens are selectable within a pivot through pull-down menu 176 and an item—e.g. “! Insight (same Internet traffic)” 178—may be selected using the same comparison criteria—e.g. a 28 day range with the current range being Jun. 30, 2010 to Jul. 27, 2010 and the previous 28 days being compared.

Having described and illustrated the principles of the invention in a preferred embodiment thereof, it should be apparent that the invention can be modified in arrangement and detail without departing from such principles. We claim all modifications and variation coming within the spirit and scope of the following claims.

APPENDIX I

| 1: | <!--- Copyright 1999 Webtrends Corporation ---> |
|---|---|
| 2: | <!--- http://www.webtrends.com ---> |
| 3: | <!--- Modification of this code is not allowed and will |
| permanently disable your account ---> | |
| 4: | <script language=″JavaScript1.2″> |
| 5: | <!--- |
| 6: | var code = ″″; |
| 7: | var ORDER = ″<% ORDER %>″ |
| | var SERVER = “”; |
| 8: | var title = escape(document.title); |
| 9: | var url = window.document.URL; |
| 10: | var orderstr = escape(order); |
| 11: | var get = |
| ″http://stats.webtrendslive.com/scripts/enterprise.cgi″; | |
| 12: | get += ″?sid=000-99-9-7-27-7349&siteID=232″; |
| 13: | get += ″&title=″ + title + ″&url=″ + url; |
| 16: | document.write(″<″ + ″script src=‘″ + get + |
| ″’></script>″); | |
| 17: | //--> |
| 18: | </script> |
| 19: | <script language=″JavaScript1.2″> |
| 20: | document.write(code); |
| 21: | document.write(″<″ + ″!---″); </script> |
| 22: | <img |
| src=″http://stats.webtrendslive.com/scripts/enterprise3.cgi?si | |
| d=000-99-9-7-27- | |
| 23: | 7349&siteID=232&url=″> |
| 24: | <script language=″JavaScript1.2″> |
| 25: | document.write(″ ---″ + ″>″); |
| 26: | </script> |
| 27: | <noscript> |
| 28: | <img |
| src=″http://stats.webtrendslive.com/scripts/enterprise3.cgi?si | |
| d=000-99-9-7-27-29: 7349&siteID=232&url=″> | |
| 30: | </noscript> |
| 31: | <!--- End of Webtrends Counter insertion ---> |

APPENDIX II
<%
ORDER = “D1;”
FOR i = 0 to UBOUND(orders)
ORDER = ORDER + product(i) & “,” & category(i) >>
& “,” & number_sold(i) & “,” & unit_price (i) >>
& “;”
NEXT
%>
(‘>>’ indicates line continues)

What is claimed is:

1. A system for presenting analytics data, comprising:
a template server including at least one natural language statement and data field; and
an analytics database including a tracked or calculated analytic value;
the system configured to substitute the analytic value in place of the data field within the natural language statement to form a completed natural language statement, and serve the natural language statement to a device requesting such a completed statement over a network.

2. The system of claim 1, wherein the template server includes a plurality of templates, each template associated with a particular analytics report and including a plurality of natural language statements, wherein the particular analytics report is served to a computer requesting the report over the wide area network.

3. The system of claim 2, wherein each of the plurality of natural language statements includes at least one data field, wherein the system is further configured to remove an incomplete natural language statement from the template if a data field associated with the incomplete natural language statement is missing.

4. A system for presenting analytics data, comprising:
an analytics database including a tracked and/or calculated analytic value;
a report engine configured to display analytics trends along a timeline;
an data feed receiver configured to receive a designated data feed and plot information from the designated data feed along the timeline; and
the report engine being further configured to display the data feed concurrently with the analytics trends, including the information plotted along the timeline.

5. A method for merging RSS feed data with graphical data comprising:
presenting analytics data in a chart or graph along a timeline;
allowing entry of an RSS feed and associating the entered RSS feed with the chart or graph, said RSS feed publishing an article at a designated time;
plotting the designated time of the article along the timeline of the chart or graph using an indicator; and
presenting at least a portion of the RSS article, and the indicator, concurrently with the chart or graph.

6. A method for displaying data in a field comprising the steps of:
tracking an analytic value over a time period;
displaying the analytic value as data points over the time period on a graph;
determining where within the time period the analytic value corresponds to a special time period; and
displaying an indicia orthogonal to a time axis of the graph indicating the special time period, wherein the indicia is adjacent to the analytic value at the special time period.

7. The method of claim 6, wherein the special time period is a repeating element over the time period, the repeating time period being a weekend.

8. The method of claim 7, wherein the indicia is a vertical bar of a contrasting appearance to a remainder of the graph, the contrasting appearance being a grayscale that indicates on the graph which web analytic value occur on weekends as opposed to weekdays.

9. The method of claim 6, further including tracking the web analytic value over a different time period and displaying the second time period web analytic value on the graph.

10. The method of claim 9, further including:
calculating a difference between the time period and different time period with respect to the occurrence of weekends within the time period and second time period; and
shifting the time period or different time period on the graph by the calculated amount so that the indicia indicating the special time period is aligned between the time period and second time period.

11. The method of claim 9, wherein the special time periods are weekend days, the method further including the step of allowing selection of a plurality of time periods being a multiple of 7 days so that the weekend days of the first time period and the different time period are aligned on the graph.
